(19) United States
(12) Patent Application Publication
(10) Pub. No.: US 2025/0026080 A1
(43) Pub. Date: Jan. 23, 2025

(54) AUTOMATED SYSTEMS AND METHODS FOR PRODUCTION OF 3D MOLDS

(71) Applicant: MATTHEWS INTERNATIONAL CORPORATION, Pittsburgh, PA (US)

(72) Inventors: Paul TUNIS, Sewickley, PA (US); Ethan GAGORIK, Coraopolis, PA (US)

(21) Appl. No.: 18/779,521

(22) Filed: Jul. 22, 2024

Related U.S. Application Data
(60) Provisional application No. 63/528,238, filed on Jul. 21, 2023.
(60) Provisional application No. 63/553,753, filed on Feb. 15, 2024.

(51) Int. Cl. B29C 64/393; B33Y 50/02; G06T 7/00; G06V 10/82; G06V 20/64; G06V 30/14

(52) U.S. Cl. CPC B29C 64/393; B33Y 50/02; G06T 7/0008; G06V 10/82; G06V 20/64; G06V 30/14; G06T 2207/20081; G06T 2207/20084; G06T 2207/20108; G06T 2207/30144

(57) ABSTRACT

Systems and methods of creating a mold design for casting a metal product are described herein. The method can include receiving, by a processor, product design information for one or more metal products, preprocessing, by the processor, the product design information to create a pre-processed file, creating, by the processor, one or more mold designs using the preprocessed file, analyzing, by the processor, the one or more mold designs to detect the presence or absence of defects, nesting, by the processor, the one or more mold designs in a work area, and generating, by the processor, printing instructions for the one or more mold designs.

### CROSS-REFERENCE TO RELATED APPLICATIONS

This application claims priority to U.S. Provisional Application No. 63/528,238 filed Jul. 21, 2023 and U.S. Provisional Application No. 63/553,753 filed Feb. 15, 2024. The entirety of each these applications is hereby incorporated by reference in their entireties.

### BACKGROUND

3D printing (also referred to as additive manufacturing) offers many advantages, especially in the foundry or metal casting industry. For example, under conventional sand molding techniques, complex parts and part geometries might be difficult or impossible to fabricate. 3D printing is often used for rapid prototyping a single component within a more complex assembly, or sand cores. The process allows for the mass production of a product and decreases production time compared to the use of traditional molds.

However, drawbacks exist when producing custom molds. For example, each custom mold requires the generation of a new 3D file. When performed manually, generating 3D files may be a time-intensive process that is prone to errors. Additionally, the initial data and artwork for the custom parts are not always well suited for translation into a 3D molding program. A further drawback is that quality assurance, in conventional workflows, is only performed after the casting has been performed, and thus the bulk of the expense of manufacturing the part has already been incurred. These quality assurance systems also rely on external imaging systems, which may be costly. As such, there exists a need for an automated process to generate molds and automatically detect errors to remove human error and reduce labor and other costs while decreasing lead time and backlog in the generation of custom 3D molds.

### SUMMARY

Systems and methods of creating a mold design for casting a product are described herein. The method can include receiving, by a processor, product design information for one or more metal products, preprocessing, by the processor, the product design information to create a pre-processed file, creating, by the processor, one or more mold designs using the preprocessed file, analyzing, by the processor, the one or more mold designs to detect the presence or absence of defects, nesting, by the processor, the one or more mold designs in a work area, and generating, by the processor, printing instructions for the one or more mold designs.

In some embodiments, the preprocessing includes editing, by the processor, the product design information to at least one of an encapsulated postscript (EPS) vector, Portable Document Format (PDF), or Scalable Vector Graphics (SVG).

In some embodiments, the analyzing includes rendering, by the processor, a two-dimensional image for each of the one or more mold designs; classifying, by the processor, each two-dimensional image using a machine learning algorithm; and generating, by the processor, an error flag in response to the classification corresponding to the presence of a defect.

In some embodiments, the machine learning algorithm is a convolutional neural network.

In some embodiments, the method further includes training the machine learning algorithm on a data set of images including labeled defects.

In some embodiments, rendering the two-dimensional image further comprises mirroring elements associated with a cavity in the one or more mold designs.

In some embodiments, generating the printing instructions includes slicing, by the processor, the one or more mold designs into a plurality of two-dimensional slices.

In some embodiments, the method further includes creating, by the manufacturing device, the mold by an additive manufacturing process according to the printing instructions.

In some embodiments, creating the mold by an additive manufacturing process includes printing the mold with sand.

In some embodiments, the analyzing includes extracting, by the processor, text from the one or more mold designs using optical character recognition, and analyzing, by the processor the text for at least one of spelling errors, character alignment, or character size consistency.

A system for creating a mold design for casting a product, includes a processor, and a non-transitory, computer-readable storage medium in operable communication with the processor. The computer-readable storage medium contains one or more programming instructions that, when executed, cause the processor to receive product design information for one or more metal products, preprocess the product design information to create a pre-processed file, create one or more mold designs using the preprocessed file, analyze the one or more mold designs to detect the presence or absence of defects, nest the one or more mold designs in a work area, and generate printing instructions for the one or more mold designs.

In some embodiments, the programming instructions to preprocess further cause the processor to edit the product design information and convert the product design information to at least one of an encapsulated postscript (EPS) vector, Portable Document Format (PDF), or Scalable Vector Graphics (SVG).

In some embodiments, the programming instructions to analyze further cause the processor to render a two-dimensional image for each of the one or more mold designs, classify each two-dimensional image using a machine learning algorithm, and generate an error flag in response to the classification corresponding to the presence of a defect.

In some embodiments, the machine learning algorithm is a convolutional neural network.

In some embodiments, the programming instructions further cause the processor to train the machine learning algorithm on a data set of images comprising labeled defects.

In some embodiments, the programming instructions to render further cause the processor to mirror elements associated with a cavity in the one or more mold designs.

In some embodiments, the programming instructions to generate the printing instructions further cause the processor to slice the one or more mold designs into a plurality of two-dimensional slices.

In some embodiments, the system further includes a manufacturing device. The programming instructions can further cause the processor to create, by the manufacturing device, the mold by an additive manufacturing process according to the printing instructions.

In some embodiments, the manufacturing device prints with sand.

In some embodiments, the programming instructions to analyze further cause the processor to extract text from the one or more mold designs using optical character recognition, and analyze the text for at least one of spelling errors, character alignment, or character size consistency.

### BRIEF DESCRIPTION OF THE DRAWINGS

FIG. 1 depicts an illustrative manufacturing system in accordance with an embodiment.

FIG. 2 illustrates a flow diagram for creating a mold for casting a metal product in accordance with an embodiment.

FIG. 3A illustrates an example data file in a text format for artwork in accordance with an embodiment.

FIG. 3B illustrates a rendering of the data file in FIG. 3A in accordance with an embodiment.

FIG. 4A illustrates an example procedural preprocessing network in accordance with an embodiment.

FIG. 4B illustrates an example procedural processing network in accordance with an embodiment.

FIG. 4C illustrates an example procedural rendering network in accordance with an embodiment.

FIG. 5 illustrates a flow diagram for automated error detection in accordance with an embodiment.

FIG. 6 illustrates an example neural network for classifying a mold design for automated error detection in accordance with an embodiment.

FIG. 7A illustrates an example three-dimensional view of nested molds in accordance with an embodiment.

FIG. 7B illustrates a two-dimensional slice, generated for printing instructions, of the example of FIG. 7A.

FIG. 8 illustrates a block diagram of a computing device for implementing the various methods and processes described herein in accordance with an embodiment.

### DEFINITIONS

As used herein, the term “about” when immediately preceding a numerical value means a range of plus or minus 10% of that value, for example, “about 50” means 45 to 55, “about 25,000” means 22,500 to 27,500, etc., unless the context of the disclosure indicates otherwise, or is inconsistent with such an interpretation.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

As used herein, a “filling ratio” means the ratio of the volume of the nanowires to the volume of the nanowires and the volume of space between the nanowires. For example, the filling ratio of a plurality of nanowires in an electrode can be 20%.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those skilled in the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

### DETAILED DESCRIPTION

This disclosure is not limited to the particular systems, devices and methods described, as these may vary. The terminology used in the description is for the purpose of describing the particular versions or embodiments only and is not intended to limit the scope.

The described technology generally relates to systems, methods, and computer program products for generating molds and/or related tooling (“a metal casting mold” or “tooling”) for creating products through a casting process. In some embodiments, the casting molds can be created using an additive manufacturing technique. The methods and systems described herein can be used with various materials, including, without limitation, ferrous metals, non-ferrous metals, bronze, precious metals, aluminum, and/or combinations thereof, and/or the like. The methods and systems described herein can be used to create various products, including plaques, markers, memorials, signs, mechanical parts, and/or the like. A mold created according to some embodiments can be used in various casting processes, including, without limitation, sand casting, shell molding, permanent mold casting, investment casting, and die casting.

Some embodiments are directed to a method of generating a mold, the method comprising obtaining a product design through a digital input, manipulating the digital input to prepare a mold information, and making a mold from the mold information using an additive manufacturing process. In some embodiments, a method of making a cast product may comprise obtaining a product design through a digital input, manipulating the digital input to prepare the mold information, making a mold from the mold information using an additive manufacturing process, positioning the mold in a build area, forming a cast part or a cast product from the mold using a cast material; and, optionally, finishing the cast product per customer specifications. In some embodiments, one or more cast parts are needed for the cast product. In some embodiments, the digital input is manipulated/modified to optimize a mold design for the additive manufacturing process. In some embodiments, the digital input may be manipulated/modified to make a mold design by optimizing part size, dimensional depth, dimensional profile, profilometry (surface roughness/finish), strength, porosity, compaction, orientation, feature complexity, or the like. This manipulation and/or modification of the digital input can optimize the final product and/or processing characteristics across the scope of manufactured products. In some embodiments, the feature complexity may include typefaces or design aspects. In some embodiments, individual mold designs may be nested to optimize material use and production speed during the additive manufacturing process.

A variety of additive manufacturing technologies will be known to a person of skill in the art. Such technologies include, for example, binder jetting, directed energy deposition, material extrusion, material jetting, powder bed fusion, sheet lamination, and vat photopolymerization. These technologies may use a variety of materials for an additive manufacturing process, including various plastics and polymers, metals and metal alloys, ceramic materials, metal clays, organic materials, and the like. Any additive manufacturing technology and substrate suitable for the production of molds of embodiments herein and compatible with the molding of products, or compatible with the manufacturing of molds that may be subsequently used to mold products, is within the scope of the present disclosure. Likewise, other methods of additive manufacturing and associated materials, whether presently available or yet to be developed, are intended to be included within the scope of the present disclosure.

Systems can be assembled to aid in the generation of molds for casting a metal product. In some embodiments, the system comprises a processor, a manufacturing device operably connected to the processor, and a non-transitory, computer-readable medium storing instructions. The instructions, when executed, can cause the processor to automatically generate a mold for casting a metal product using product design information. In some embodiments, the instructions, when executed, can cause the processor to receive product design information of the metal product, preprocess the product design information to create a pre-processed file, create a mold design using the preprocessed file, and analyze the mold design to detect the presence or absence of defects. In some embodiments, the instructions, when executed, can further cause the processor to generate printing instructions for the mold design and nest the printing instructions in a work area. In some embodiments, the manufacturing device is configured to access the printing instructions from the processor and create the mold insert by an additive manufacturing process according to the printing instructions.

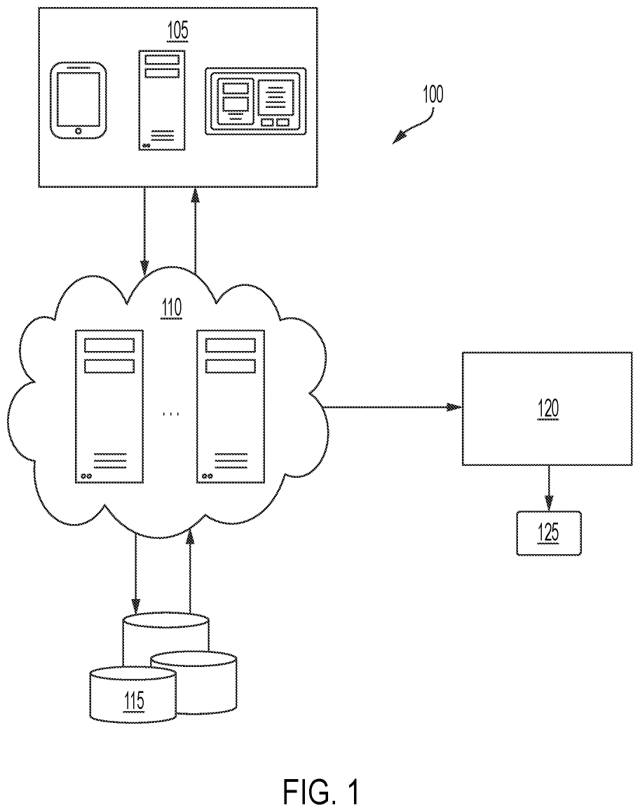

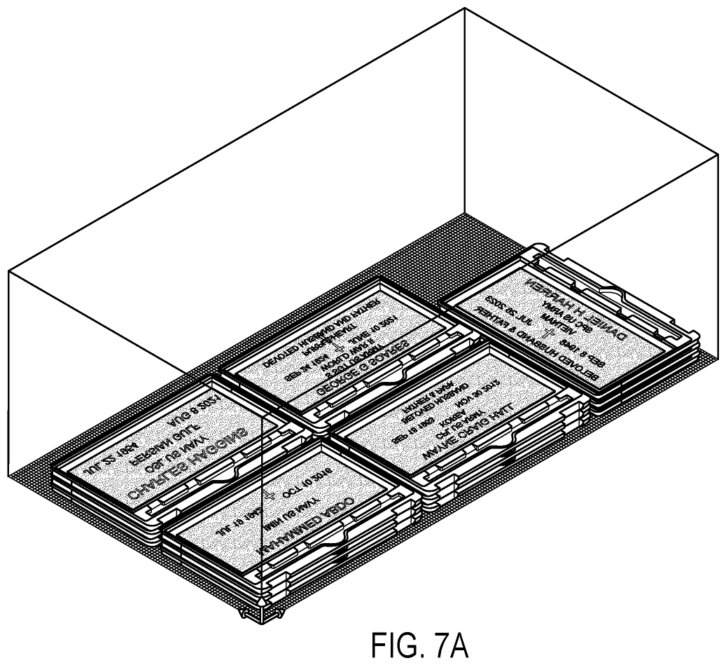

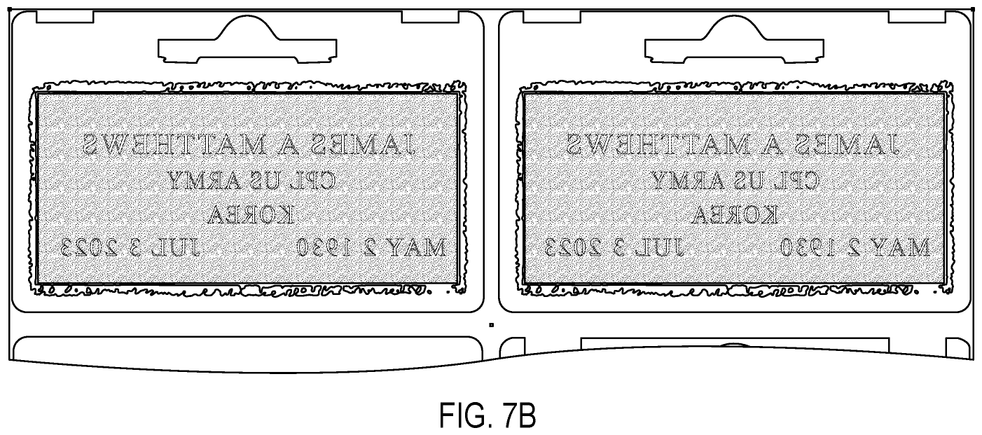

FIG. 1 depicts an illustrative manufacturing system according to an embodiment. As shown in FIG. 1, the manufacturing system 100 can include one or more system logic devices 110, which can generally include a processor, a non-transitory memory or other storage device for housing programming instructions, data or information regarding one or more applications, and other hardware, including, for example, the processing unit (CPU) 704, system memory 706, communication interface 712, and/or memory devices 708/710 depicted in FIG. 7 and described below in reference thereto. In some embodiments, the system logic devices 110 can include server computing devices, workstation computing devices (personal computers or “PCs”), and/or the like. In some embodiments, the system logic devices 110 can be a part of a control system for a mold manufacturing device 120, such as an additive manufacturing device or three-dimensional printing device.

In some embodiments, the programming instructions may include a mold manufacturing application (the “manufacturing application”) configured to, among other things, design and/or generate a mold. The system logic devices 110 can be in operable communication with client logic devices 105, including, but not limited to, server computing devices, personal computers (PCs), kiosk computing devices, mobile computing devices, laptop computers, smartphones, tablet computing devices, cloud computing devices, or any other logic and/or computing devices now known or developed in the future.

In some embodiments, the manufacturing application may be accessible through various platforms, such as a client application, a web-based application, over the Internet, an e-commerce portal, and/or a mobile application (for example, a “mobile app” or “app”). According to some embodiments, the manufacturing application may be configured to operate on each client logic device 105 and/or to operate on a system logic device 110 accessible to client logic devices over a network, such as the Internet. All or some of the files, data and/or processes (for example, source information, data sets, or the like) used for accessing information may be stored locally on each client logic device 105 and/or stored in a central location and accessible over a network. In some embodiments, the processes may include a machine learning model.

In an embodiment, one or more data stores 115 may be accessible by the client logic devices 105 and/or the system logic devices 110. In some examples, the data stores 115 may include information sources having information used to design and/or generate a mold or customized portions of molds. For example, data stores 115 may include, without limitation, information from product catalogs, historical mold information, mold pattern information (e.g., mold templates, dimensions, cost information, and/or the like), e-commerce information, production information (e.g., SKU number), material information, and/or the like. In some embodiments, the data stores 115 may include information obtained from multiple data sources, including third-party data sources.

Although the one or more data stores 115 are depicted as being separate from the logic devices 105, 110, embodiments are not so limited. All or some of the one or more data stores 115 may be stored in one or more of the logic devices 105, 110.

The system logic devices 110 may receive product specifications for a product. The product specifications may be analyzed by the manufacturing application to generate mold information. In some embodiments, the product specifications may be stored in the form of a digital file. The mold information may be transmitted to a manufacturing device 120, such as an additive manufacturing system. The manufacturing device 120 may generate a mold 125 based on the mold information. For example, the manufacturing application may generate, look up, or otherwise obtain information from the product specifications and translate this data into mold information that can be used by the manufacturing device 120 to generate the mold 125. In some embodiments, the mold information may be stored in the form of a digital file (e.g., an *.stl file). The mold 125 may be used in various casting processes to generate a product, including, without limitation, sand casting, shell molding, permanent mold casting, investment casting, and die casting.

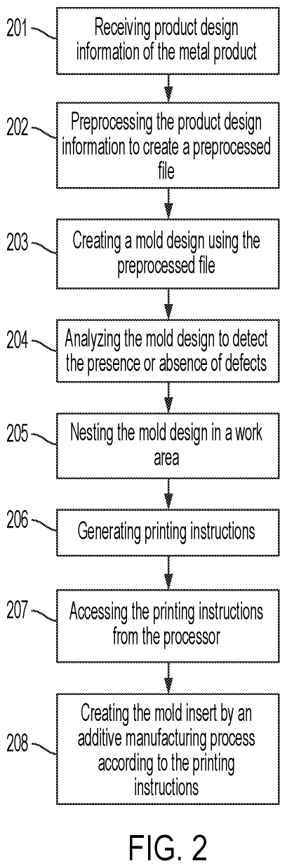

FIG. 2 illustrates a flow diagram of a method for creating a mold for casting a metal product. The method comprises receiving 201 product design information of the metal product, preprocessing 202 the product design information to create a pre-processed file, creating 203 a mold design using the preprocessed file, and analyzing 204 the mold design to detect the presence or absence of defects. In some embodiments, the method further comprises generating 205 printing instructions for the mold design and nesting 206 the printing instructions in a work area. In some embodiments, the method further comprises accessing 207 the printing instructions from the processor and creating 208 the mold insert by an additive manufacturing process according to the printing instructions.

In some embodiments, receiving 201 the product design information of the metal product is performed by a processor. The mold manufacturing system may receive a product design to be manipulated/modified using scanning technologies and/or manual data manipulation to prepare files for use with additive manufacturing and other three-dimensional printing systems. The digital input may be in the form of engineering files, such as point cloud files, polygon mesh files, spline surface files, Boolean solid geometry files, or other related computer-aided design (CAD) files, raster/vector type files, and/or the like. In some embodiments, the manufacturing system uses stereolithography (*.stl) files for use with additive manufacturing systems.

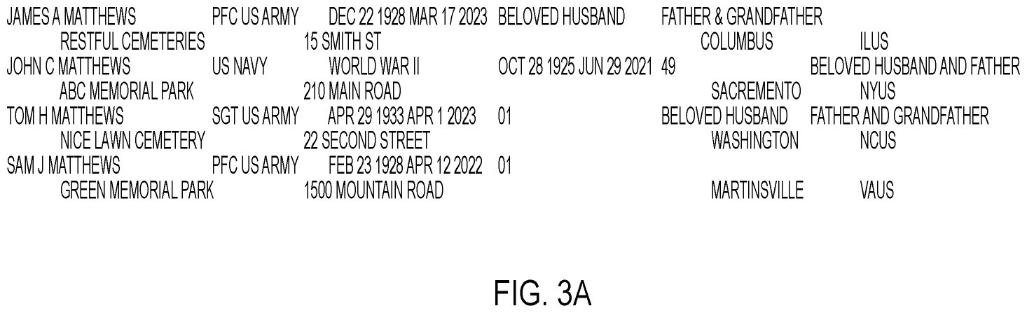

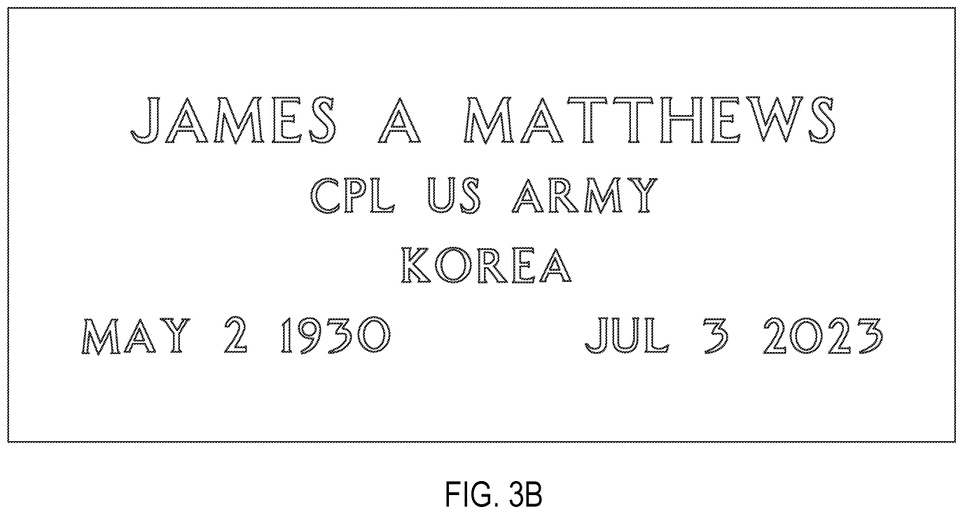

In certain embodiments, the digital input does not directly include a geometry of the mold. For example, the product design information may be provided in a text file, as illustrated in FIG. 3A. The product design information may be structured or unstructured.

In some embodiments, the product design information is preprocessed 202 by the processor. Processing 202 may include parsing the product design information and converting the file into an image and/or engineering file. The engineering file may be a two-dimensional drawing, such as in the encapsulated postscript (EPS) vector form, Portable Document Format (PDF), or Scalable Vector Graphics (SVG). For example, the product design information in FIG. 3A may be converted into the drawing illustrated in FIG. 3B. In some embodiments, the product design information is structured based on one or more assumptions (e.g., product type characteristics). Product type characteristics may be associated with a class of products and/or an individual order. In some embodiments, product type characteristics include at least one of text layout, typeface, backing substrate shape, texture, depth of field, surface structure, material, and associated material properties (e.g., reflectance, color, gloss, anisotrophy, scattering properties, etc.). For example, when creating a plaque, the product design information may directly define or reference a product type with various dimensions of the plaque (i.e., length, width and depth), standard ornamentations or decorations (e.g., specific borders, raised or lowered features, and other similar decorations), and other standard features. In some embodiments, a portion of these features may be provided using an interactive editing tool. The interactive editing tool may add additional detail, such as text (e.g., a person's name, relevant dates, and other information related to the product being created), additional decorations (e.g., images), and any other elements that the design system is configured to support.

In some embodiments, creating 203 the mold design using the digital input or preprocessed file is performed by the processor. The mold design may be procedurally generated. For example, the mold designs may be generated in Houdini, but any three-dimensional modeling software could be used. An example procedural network may include task operators for preprocessing two-dimensional vector information into a three-dimensional textured geometry, processing the three-dimensional textured geometry into a proper format (e.g., changing size and file type), rendering a reverse image of the mold for quality control, and reviewing the reverse image for quality control.

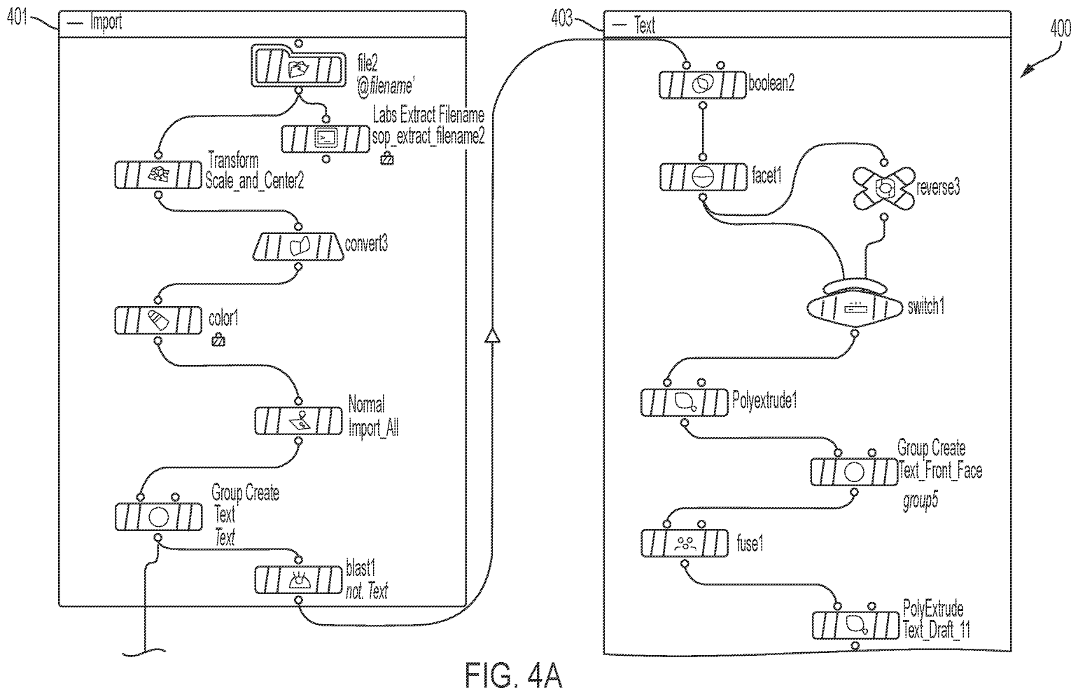

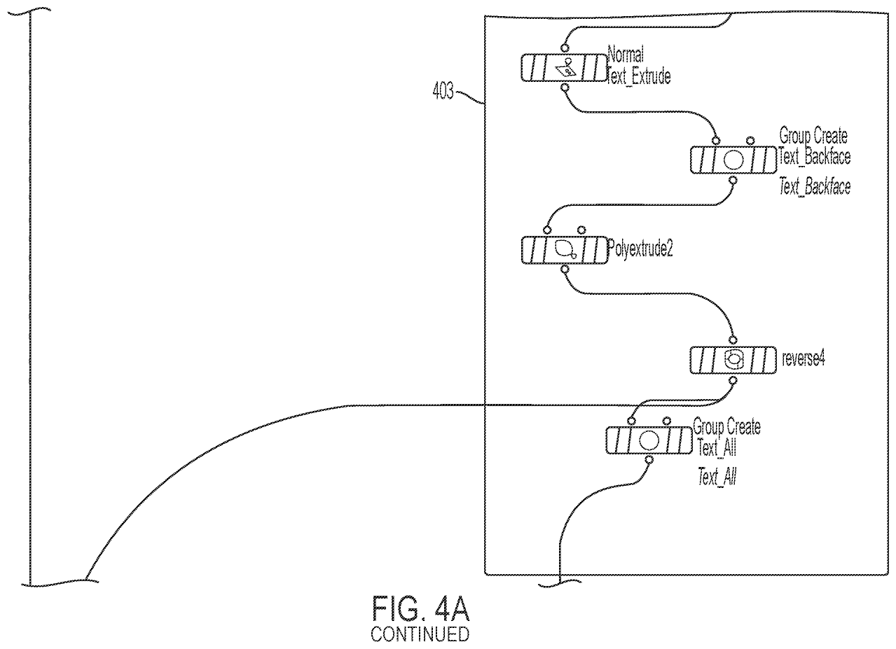

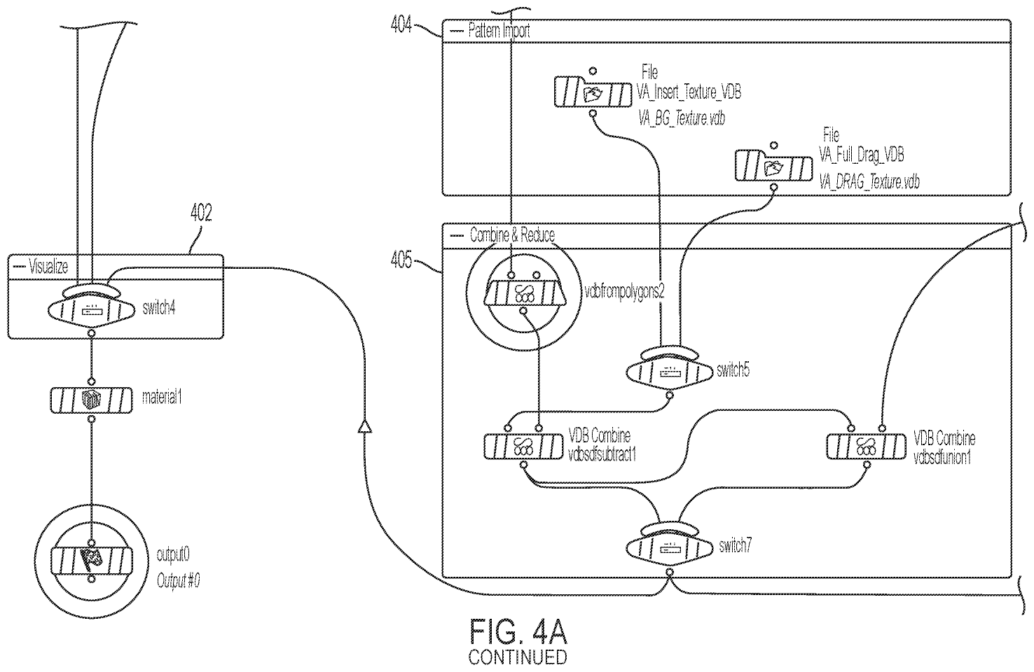

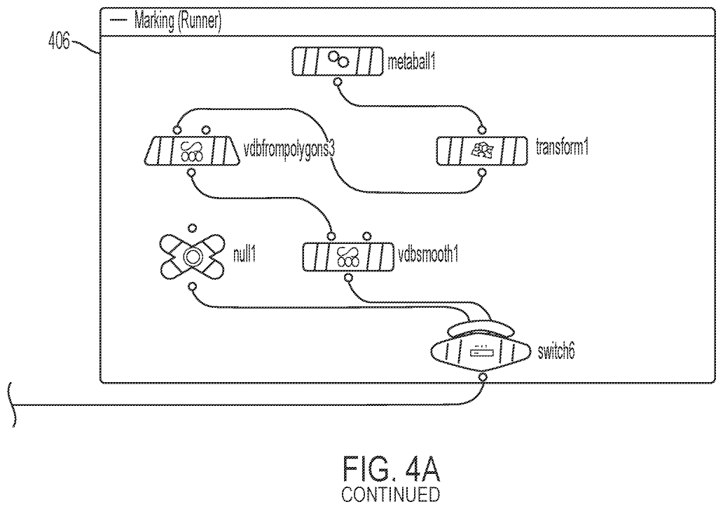

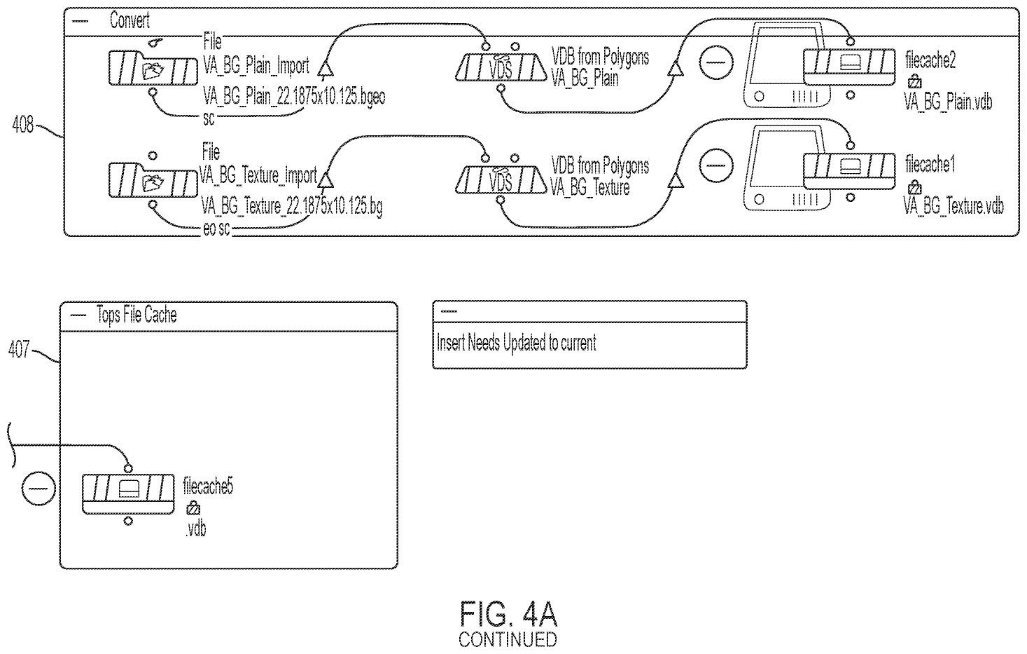

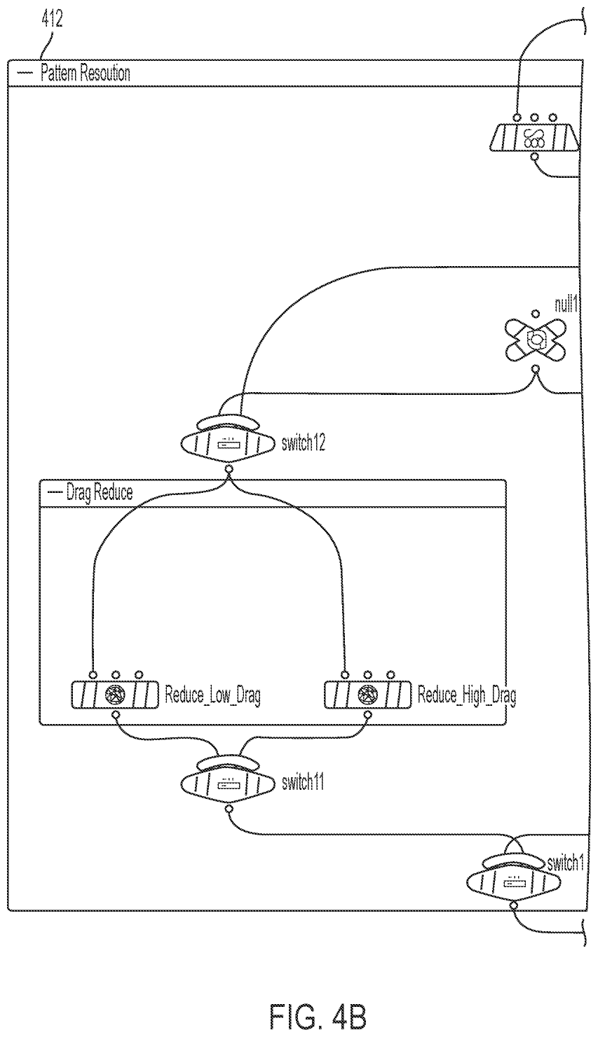

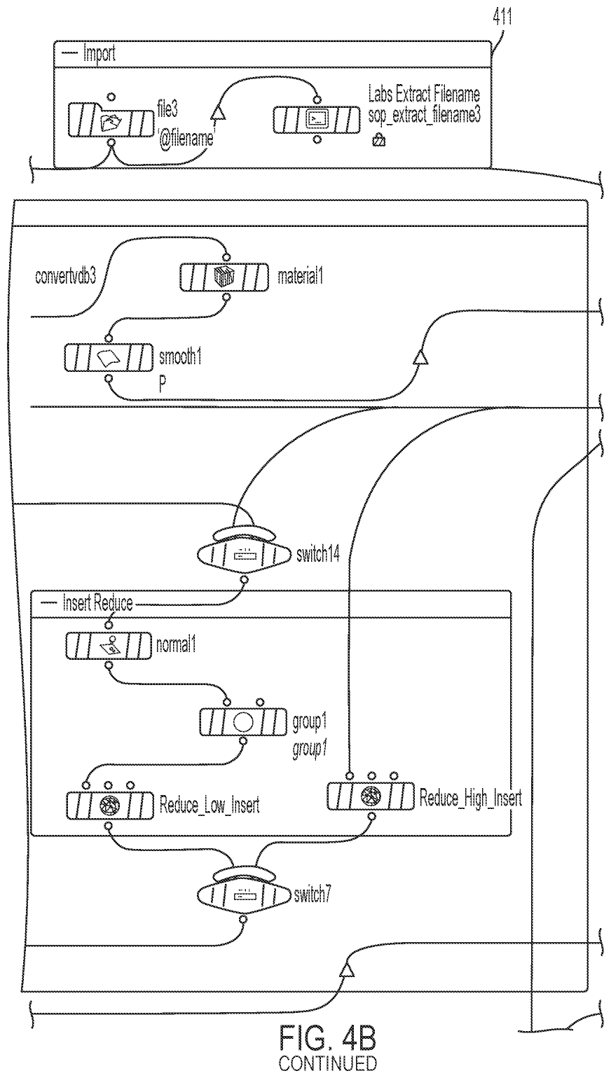

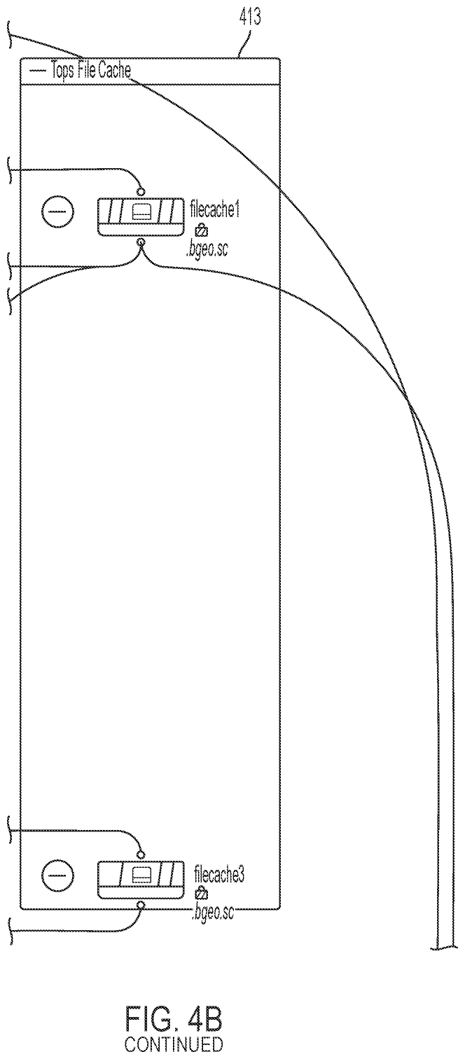

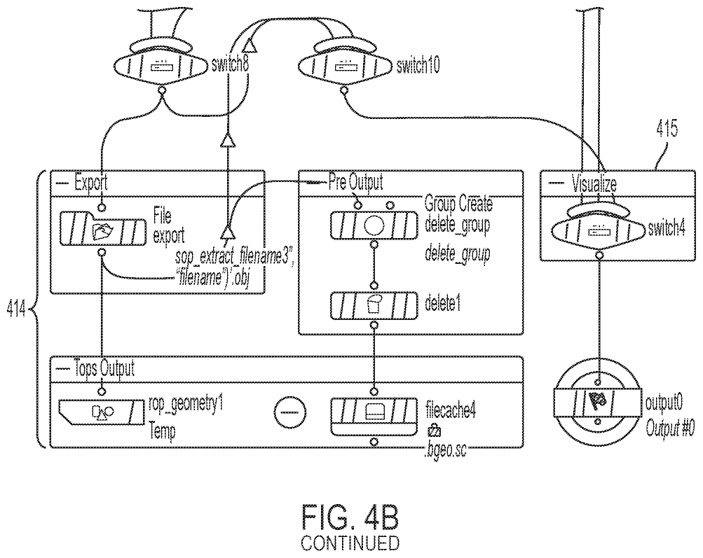

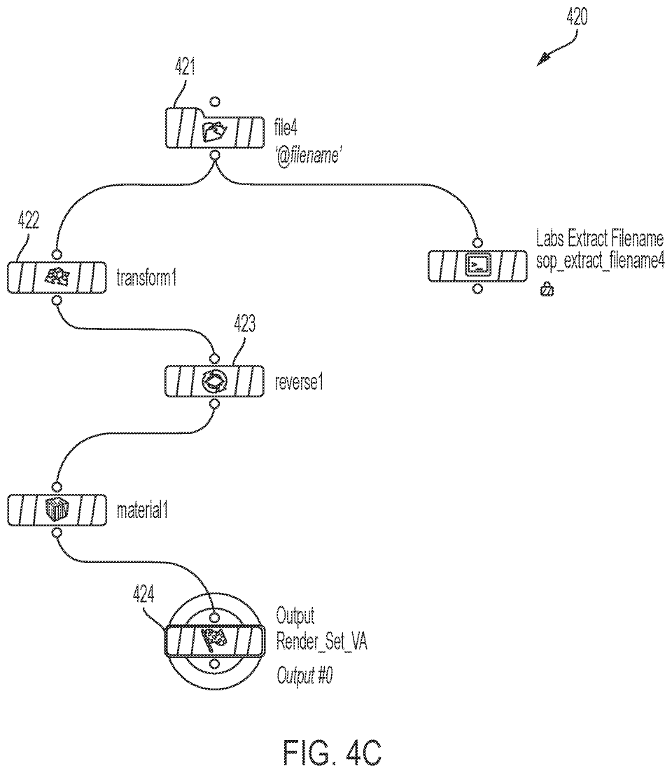

FIG. 4A illustrates an example procedural preprocessing network 400 in accordance with an embodiment. The preprocessing network 400 may include nodes configured to import 401 the product design information and convert the file into a three-dimensional file format. The preprocessing network 400 may include nodes configured to extract text or other elements 403 from the imported file. The extracted elements may have a three-dimensional geometric shape based on predetermined mold constraints. The preprocessing network 400 may include nodes configured for pattern input 404. In some embodiments, pattern input 404 includes loading a preconfigured blank mold template. The preprocessing network 400 may include nodes configured to combine and reduce 405 the imported file and the blank mold template. The combining and reducing nodes 405 may subtract the extracted elements to create a cavity. The preprocessing network 400 may further include nodes configured to add 406 identifying markings to the geometry for production purposes. In some embodiments, additional nodes may provide at least one of visualizing 402 a render of molds as they are processed, caching 407 files for inspection or further processing, and/or debugging 408 the preprocessing network 400. The output of the preprocessing network 400 may be a voxel file.

FIG. 4B illustrates an example procedural processing network 410 in accordance with an embodiment. The processing network 410 may include nodes for importing 411 files (e.g., cached files from other processes such as the preprocessing network 410 or user input). The imported files may be reduced in resolution to generate an output of a manageable file size. The resulting file, with a reduced resolution, may be exported 414 as a three-dimensional geometry file (e.g., an OBJ file). In some embodiments, additional nodes may be provided for at least one of visualizing 415 a render of molds as they are processed, caching 415 files for inspection or further processing, and/or debugging the processing network 410.

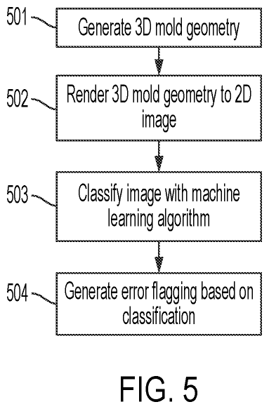

Referring back to FIG. 2, in some embodiments, analyzing 204 the mold design to detect the presence or absence of defects is performed by the processor. Referring to FIG. 5, a flow diagram for a method of automated error detection is depicted in accordance with an embodiment. Based on the mold design, the processor may generate 501 a three-dimensional mold geometry. In some embodiments, the three-dimensional mold geometry is rendered 502 to a two-dimensional image. Rendering 502 the geometry in two dimensions may lessen processing/memory requirements and simplify training for the machine learning algorithm described herein. In some embodiments, the two-dimensional image may be a slice of the three-dimensional mold geometry. The two-dimensional image may be prepared as printing instructions for an additive manufacturing device (e.g., mold manufacturing device 120). In further embodiments, pre-sliced template data may be merged with the rendered two-dimensional geometry to generate a complete two-dimensional representation of the product. The pre-sliced template data may be processed as disclosed in U.S. Provisional Application No. 63/553,753.

Briefly referring to FIG. 4C, an example procedural rendering network 420 is illustrated in accordance with an embodiment. The rendering network 420 may import a geometry 421, transform the geometry to a predetermined scale 422, reverse extracted elements such as text 423 (i.e., to adjust to how the final casted product will appear), and render an image output of the product 424.

In certain embodiments, classifying 503 the image or geometry with a machine learning algorithm is performed by the processor. The machine learning algorithm may be supervised or unsupervised. Example machine learning algorithms for classification include convolutional neural networks, artificial neural networks, support vector machines, and K-Means Clustering, and K-Nearest Neighbor algorithms. The machine learning algorithm may be trained to classify particular errors and/or intended structures (e.g., shapes, text, or figures) in a mold design. The machine learning algorithm may output a probability of an input including a particular error or an intended structure. Training sets may include labeled images or models. An image training set may include some combination of generated (e.g., rendered) imagery or photographs. For example, a training set may be generated with a set of images with known errors that are labeled accordingly. The training set may further include a set of images without errors that are labeled accordingly.

In some embodiments, the processor generates 504 error flagging based on the classification. In embodiments where the output is a probability, output by the machine learning algorithm may be compared against a threshold value to automatically generate 504 an error flag. Example errors that may be flagged include the vector not being recognized, which can result in a blank mold, visual detection of objects that are too close to one another, or visual detection of parts of the text and vectors that were not extruded properly or were produced in the wrong size. The text may also be extracted using text recognition and checked for spelling, letter sizes, etc. In some embodiments, potential mold issues that may cause flow problems are detected. In certain embodiments, errors flags are generated 504 with different types and/or importance levels (e.g., warning or critical). In certain embodiments, multiple classifications can be weighted and combined to generate 504 error flags.

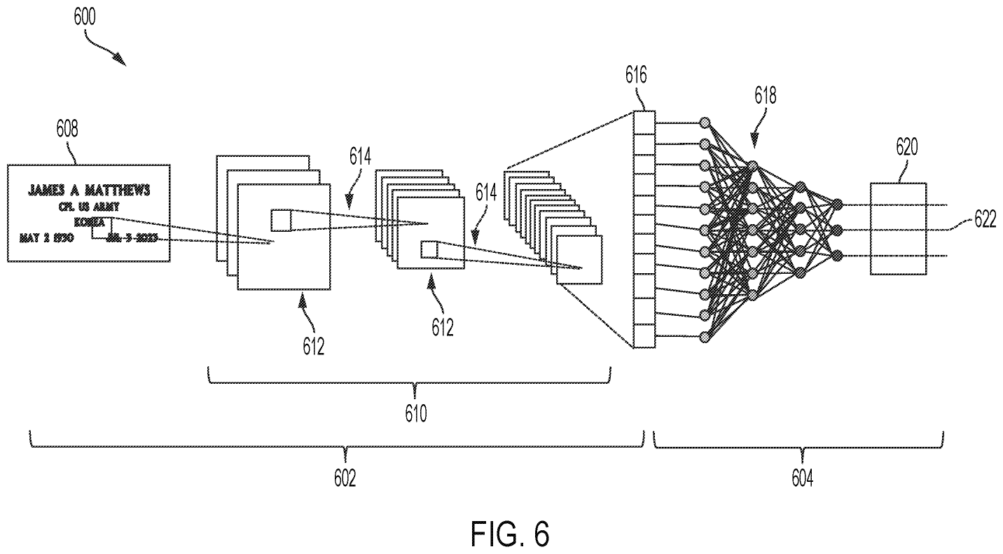

FIG. 6 illustrates a convolutional neural network 600 for classifying a mold design for automated error detection in accordance with an embodiment. A convolutional neural network may include feature extraction 602 and classification 604 layers. Feature extraction layers 602 may include featuring mapping 610 the input 608 by applying a series of convolution and rectified linear activation function (ReLU) layers 612. Convolution layers 612 maintain relationships between pixels or voxels in an image or model, by learning features using a kernel. ReLU may introduce the property of non-linearity to the model and solve the vanishing gradients problem (i.e., the partial derivative of the loss function approaches a value close to zero, and the partial derivative vanishes so the network cannot learn through back propagation). Feature extraction 602 may include pooling layers 614 that reduce the spatial size to reduce network complexity. The extracted features may be flattened into a vector in a flatten layer 616.

The pooling layers 614 may employ a max pooling algorithm and/or a dropout algorithm. A max pooling algorithm may “pool” data from the individual convolutional layers 612 to simplify the parameters. A dropout algorithm may randomly delete a predetermined percentage of the data during training. The max pooling and dropout algorithms may prevent overfitting the model.

The classification layers 604 may include a neural network of fully connected layers 618. The neural network 618 may be fully connected in that every neuron in one layer is connected to every neuron in another layer. As a result of this connection, every input of the input vector, generated by the flatten layer 616, influences every output of the output vector 622. The classification layers 604 may include a loss layer or function 620 that determines how training corrects for a detected deviation between an output of the network and labels in training data. In some embodiments, the loss function 620 is the Softmax loss function which can predict a single classification from a set of mutually exclusive classifications. Alternatively, Sigmoid cross-entropy loss may be used for predicting independent probability values across classifications. A person of ordinary skill in the art will recognize other loss functions that can be used to determine errors. An output 622 may be generated as a binary classification or a probability.

In certain embodiments, in response to the detection of no errors of a certain type, the processor may automatically proceed with generating 205 printing instructions. In some embodiments, errors of certain types may require corrective action before generating 205 printing instructions. In response to some error flags, the processor may automatically modify the vector data. Alternatively, in response to some error flags, the processor may generate a recommendation for modifying the vector data. A user may either accept or deny the recommendation for automatic correction. Alternately, a user may manually correct the error based on the recommendation.

Referring back to FIG. 2, in some embodiments, nesting 205 the printing instructions in the work area is performed by the processor. Individual mold designs may be nested to optimize material use and production speed during the additive manufacturing process. FIG. 7A illustrates an example three-dimensional view of nested molds in accordance with an embodiment. Although the example depicts nesting in two dimensions (e.g., horizontally), in some embodiments, the processor can nest individual mold designs in a third dimension (e.g., vertically). In further embodiments, nesting in the third dimension may be constrained based on a limited resolution of the additive manufacturing device in the third dimension as compared to the first and second dimensions.

In some embodiments, generating 206 printing instructions for the mold design(s) is performed by the processor. Typically, additive manufacturing devices (e.g., 3D printers) cannot read geometry directly from a three-dimensional mesh file (e.g., STL or OBJ). Rather, an additive manufacturing device reads layers of data that are sliced from a three-dimensional geometry. Additive manufacturing devices may use a CLI (common layer interface) file, which is a set of two-dimensional slices that are stacked in the z direction and allow the additive manufacturing devices to generate the three-dimensional parts in the work area. In certain embodiments, slicing is done in Netfabb (i.e., an Autodesk program) using the Lua scripting language. Individual or nested mold designs may be sliced into layers for generating 206 printing instructions. FIG. 7B illustrates a two-dimensional slice of the nested example of FIG. 7A.

In some embodiments, the printing instructions are accessed 207 by a manufacturing device. The mold may be created 208 by an additive manufacturing process in the manufacturing device.

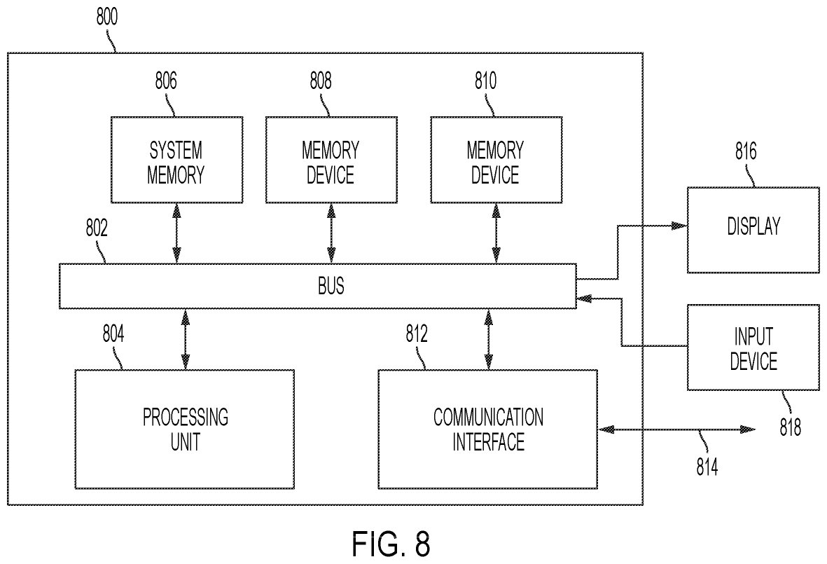

FIG. 8 is a schematic block diagram illustrating an example system 800 of hardware components capable of implementing examples of the systems and methods disclosed herein. The system 800 can include various systems and subsystems. The system 800 can include one or more of a personal computer, a laptop computer, a mobile computing device, a workstation, a computer system, an appliance, an application-specific integrated circuit (ASIC), a server, a server BladeCenter, a server farm, etc.

The system 800 can include a system bus 802, a processing unit 804, a system memory 806, memory devices 808 and 810, a communication interface 812 (e.g., a network interface), a communication link 814, a display 816 (e.g., a video screen), and an input device 818 (e.g., a keyboard, touch screen, and/or a mouse). The system bus 802 can be in communication with the processing unit 804 and the system memory 806. The additional memory devices 808 and 810, such as a hard disk drive, server, standalone database, or other non-volatile memory, can also be in communication with the system bus 802. The system bus 802 interconnects the processing unit 804, the memory devices 808 and 810, the communication interface 812, the display 816, and the input device 818. In some examples, the system bus 802 also interconnects an additional port (not shown), such as a universal serial bus (USB) port.

The processing unit 804 can be a computing device and can include an application-specific integrated circuit (ASIC). The processing unit 804 executes a set of instructions to implement the operations of examples disclosed herein. The processing unit can include a processing core.

The additional memory devices 806, 808, and 810 can store data, programs, instructions, database queries in text or compiled form, and any other information that may be needed to operate a computer. The memories 806, 808 and 810 can be implemented as computer-readable media (integrated or removable), such as a memory card, disk drive, compact disk (CD), or server accessible over a network. In certain examples, the memories 806, 808 and 810 can comprise text, images, video, and/or audio, portions of which can be available in formats comprehensible to human beings.

Additionally, or alternatively, the system 800 can access an external data source or query source through the communication interface 812, which can communicate with the system bus 802 and the communication link 814.

In operation, the system 800 can be used to implement one or more parts of a system in accordance with the present invention, such as system 100. Computer executable logic for implementing the diagnostic system resides on one or more of the system memory 806, and the memory devices 808 and 810 in accordance with certain examples. The processing unit 804 executes one or more computer executable instructions originating from the system memory 806 and the memory devices 808 and 810. The term “computer readable medium” as used herein refers to a medium that participates in providing instructions to the processing unit 804 for execution. This medium may be distributed across multiple discrete assemblies all operatively connected to a common processor or set of related processors.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by the embodiments described above.

What is claimed is:

1. A method of creating a mold design for casting a product, the method comprising:
receiving, by a processor, product design information for one or more metal products;
preprocessing, by the processor, the product design information to create a pre-processed file;
creating, by the processor, one or more mold designs using the preprocessed file;
analyzing, by the processor, the one or more mold designs to detect the presence or absence of defects;
nesting, by the processor, the one or more mold designs in a work area; and
generating, by the processor, printing instructions for the one or more mold designs.

2. The method of claim 1, wherein the preprocessing comprises:
editing, by the processor, the product design information; and
converting, by the processor, the product design information to at least one of an encapsulated postscript (EPS) vector, Portable Document Format (PDF), or Scalable Vector Graphics (SVG).

3. The method of claim 1, wherein the analyzing comprises:
rendering, by the processor, a two-dimensional image for each of the one or more mold designs;
classifying, by the processor, each two-dimensional image using a machine learning algorithm; and
generating, by the processor, an error flag in response to the classification corresponding to the presence of a defect.

4. The method of claim 3, wherein the machine learning algorithm is a convolutional neural network.

5. The method of claim 3, further comprising training the machine learning algorithm on a data set of images comprising labeled defects.

6. The method of claim 3, wherein rendering the two-dimensional image further comprises mirroring elements associated with a cavity in the one or more mold designs.

7. The method of claim 1, wherein generating the printing instructions comprises slicing, by the processor, the one or more mold designs into a plurality of two-dimensional slices.

8. The method of claim 1, further comprising creating, by the manufacturing device, the mold by an additive manufacturing process according to the printing instructions.

9. The method of claim 8, wherein creating the mold by an additive manufacturing process comprises printing the mold with sand.

10. The method of claim 1, wherein the analyzing comprises:
extracting, by the processor, text from the one or more mold designs using optical character recognition; and analyzing, by the processor, the text for at least one of spelling errors, character alignment, or character size consistency.

11. A system for creating a mold design for casting a product, the system comprising:
a processor; and
a non-transitory, computer-readable storage medium in operable communication with the processor, wherein the computer-readable storage medium contains one or more programming instructions that, when executed, cause the processor to:
receive product design information for one or more metal products;
preprocess the product design information to create a pre-processed file;
create one or more mold designs using the preprocessed file;
analyze the one or more mold designs to detect the presence or absence of defects;
nest the one or more mold designs in a work area; and
generate printing instructions for the one or more mold designs.

12. The system of claim 11, wherein the programming instructions to preprocess further cause the processor to:
edit the product design information; and
convert the product design information to at least one of an encapsulated postscript (EPS) vector, Portable Document Format (PDF), or Scalable Vector Graphics (SVG).

13. The system of claim 11, wherein the programming instructions to analyze further cause the processor to:
render a two-dimensional image for each of the one or more mold designs;
classify each two-dimensional image using a machine learning algorithm; and
generate an error flag in response to the classification corresponding to the presence of a defect.

14. The system of claim 13, wherein the machine learning algorithm is a convolutional neural network.

15. The system of claim 13, wherein the programming instructions further cause the processor to:
train the machine learning algorithm on a data set of images comprising labeled defects.

16. The system of claim 13, wherein the programming instructions to render further cause the processor to:
mirror elements associated with a cavity in the one or more mold designs.

17. The system of claim 11, wherein the programming instructions to generate the printing instructions further cause the processor to:
slice the one or more mold designs into a plurality of two-dimensional slices.

18. The system of claim 11, further comprising a manufacturing device, wherein the programming instructions further cause the processor to:
create, by the manufacturing device, the mold by an additive manufacturing process according to the printing instructions.

19. The system of claim 18, wherein the manufacturing device prints with sand.

20. The system of claim 11, wherein the programming instructions to analyze further cause the processor to:
extract text from the one or more mold designs using optical character recognition; and
analyze the text for at least one of spelling errors, character alignment, or character size consistency.
